(19) United States
(12) Patent Application Publication
(10) Pub. No.: US 2002/0139650 A1
(43) Pub. Date: Oct. 3, 2002

(54) Service switching device of the cap type

(76) Inventors: Wolfgang Suss, Konigswalde (DE); Wolfgang Pump, Annaberg-Buchholz (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/113,414

(22) Filed: Apr. 1, 2002

(30) Foreign Application Priority Data
Mar. 30, 2001 (DE) 101 16 001.1

(51) Int. Cl. H01H 9/02

(52) U.S. Cl. 200/307

(57) ABSTRACT

A service switching device of the cap type is described, and has an auxiliary switch which contains a microswitch and is fitted on a rear narrow face. The service switching device has a groove or strip running parallel to the narrow face on each of the broad faces adjacent to the rear narrow face wall. Wall sections are integrally formed on the rear wall of the auxiliary switch housing, project parallel to the broad faces in the direction of the narrow face, and are matched to the grooves or strips, such that the auxiliary switch housing can be mounted on the service switching device by pushing in from the front towards the mounting plane, with the microswitch at right angles to the mounting plane on the narrow face, and with the projections or strips which are integrally formed on the wall sections sliding in the grooves or strips.

### BACKGROUND OF THE INVENTION

1. Field of the Invention

The invention relates to a service switching device of the cap type.

In this context, service switching devices are, in particular, circuit breakers or fault-current circuit breakers which have at least one single or double contact point and whose housing is approximately T-shaped.

Auxiliary switches are used to detect and indicate the switch position of the service switching device. The auxiliary switches normally have the same external contour as the service switching device itself, and are fitted to one of the broad face surfaces at the side. The switch position of the moving contact piece, or possibly of the contact link on the auxiliary switch, is transmitted via suitable coupling elements, so that the switch position is indicated.

Another embodiment of the fitting of an auxiliary switch has been disclosed in Published, Non-Prosecuted German Patent Application DE 199 06 236 A1, corresponding to U.S. patent application Ser. No. 09/504,277. According to this document, the auxiliary switch is fitted to the rear narrow face surface. The auxiliary switch is a microswitch, and the housing has a projection that can be inserted into a connecting terminal opening. The plunger of the microswitch is connected via a slide, which is provided with an inclined surface, to the moving contact piece or to the moving contact lever. When the service switching device changes to the switched-off position, the slide is moved against the force of a spring, and operates the microswitch via the inclined surface.

Connecting terminals are located within the housing for the microswitch and are operated from the front face in order to connect signal lines.

2. Summary of the Invention

It is accordingly an object of the invention to provide a service switching device of the cap type which overcomes the above-mentioned disadvantages of the prior art devices of this general type, in which the mounting process is simplified and, furthermore, any excessive manual force when tightening the clamping screws of the auxiliary switch has no adverse effect on the auxiliary switch.

With the foregoing and other objects in view there is provided, in accordance with the invention, a service switching device of a cap type. The service switching device contains a housing having a mounting plane, a rear narrow face wall, and broad faces adjacent the rear narrow face wall. The broad faces have openings being grooves or slots and run parallel to the rear narrow face wall. Each of the broad faces has a respective one of the openings. An auxiliary switch having a microswitch is fitted on the rear narrow face wall. The auxiliary switch has an auxiliary switch housing with a rear wall and wall sections integrally formed on the rear wall. The walls sections project parallel to the broad faces in a direction of the rear narrow face wall. The wall sections have projections matched to the openings, such that the auxiliary switch housing can be mounted on the service switching device by pushing in from a top towards the mounting plane, with the microswitch at right angles to the mounting plane on the rear narrow face wall. The projections integrally formed on the wall sections slide into the openings on the broad faces.

This provides protection against twisting, since the auxiliary switch is fixed in an interlocking manner rather than by clamping.

In order to prevent the auxiliary switch from moving beyond a specific final position during insertion, those ends of the wall sections which are located opposite the mounting plane of the service switching device are connected to one another by a transverse wall.

Therefore, during insertion, the transverse wall comes into contact with the service switching device, and in this way prevents it from being pushed in any further.

According to a further embodiment, a latching device is integrally formed on the narrow face surface and on that wall of the auxiliary switch housing which is adjacent to the narrow face surface, and are used to latch the auxiliary switch housing in its final position. In this case, a tap which latches into a recess on the service switching device can be integrally formed on the auxiliary switch housing.

According to a further embodiment of the invention, the auxiliary switch housing is formed in two pieces, with a housing lower part and a housing upper part, which effectively acts as a cover. The housing lower part has the wall sections, the transverse wall and the tab, while, in contrast, the housing upper part has the access openings to the terminal screws.

In accordance with an added feature of the invention, the wall sections are L-shaped and the projections are free limbs pointing towards one another.

In accordance with an additional feature of the invention, the openings are U-shaped grooves, and the auxiliary switch housing has side walls. The housing has limbs disposed between the U-shaped grooves and the rear narrow face wall, and the limbs of the housing are closer to one another than the broad faces, so that the side walls lie flush with the broad faces after mounting of the auxiliary switch.

In accordance with a further feature of the invention, a moving contact piece is disposed in the housing and the rear narrow face wall has a slot formed therein. The microswitch has a plunger and an inclined surface is disposed in the auxiliary switch. A spring is disposed next to the microswitch and a slide couples the microswitch with the moving contact piece. The slide is inserted through the slot in the rear narrow face wall and acts on the inclined surface to operate the plunger of the microswitch against a force of the spring.

In accordance with another feature of the invention, the slide is L-shaped and has a limb which points towards the mounting plane, outside the rear narrow face wall, in a mounted state.

In accordance with a further added feature of the invention, a sliding piece is disposed in the auxiliary switch and the inclined surface is integrally formed on the sliding piece which interacts with the slide.

In accordance with a concomitant feature of the invention, the sliding piece is L-shaped and has a first limb having the inclined surface and a second limb running parallel to the limb of the slide. The spring is a compression spring and is disposed between the microswitch and an inner surface of the second limb of the sliding piece and acts on the slide in a sprung manner in a closing direction of a contact point.

Other features which are considered as characteristic for the invention are set forth in the appended claims.

Although the invention is illustrated and described herein as embodied in a service switching device of the cap type, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of an auxiliary switch housing, showing a side with which the auxiliary switch housing can be fitted to a service switching device according to the invention;

FIG. 2 is a perspective view of a slide;

FIG. 3 is a perspective view of a service device in an area in which the auxiliary switch housing can be mounted on the service switching device, before the slide is inserted;

FIG. 4 is a perspective view of the service switching device shown in FIG. 3, with the slide inserted;

FIG. 5 is a perspective view of the service switching device with the auxiliary switch housing latched to it; and

FIG. 6 is a sectional view through the auxiliary switch housing in order to illustrate the method of operation.

### DESCRIPTION OF THE PREFERRED EMBODIMENTS

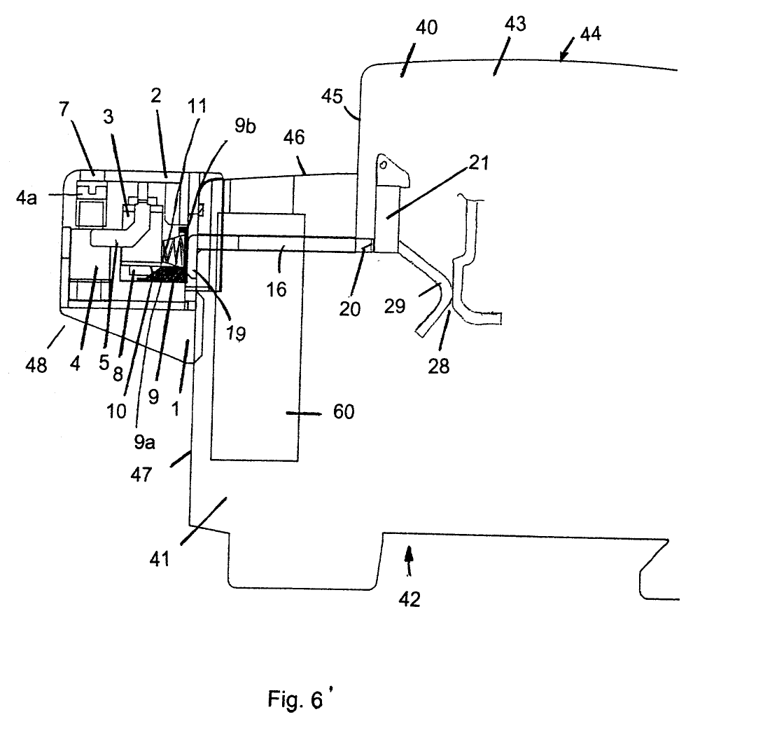

Referring now to the figures of the drawing in detail and first, particularly, to FIG. 6 thereof, there is shown a service switching device 40, for example a circuit breaker, that is of a cap type with a T-shape, and with a free end surface of a transverse web 41 forming a mounting plane 42. A free end of a longitudinal web 43 is referred to as an anterior front face 44, adjacent to which there are front narrow face walls 45, which merge into rear front surfaces 46. Only the left front narrow face wall 45 and the left rear front wall 46 are shown in the FIG. 6. The rear front walls 46 are adjacent to rear narrow face walls 47, with an auxiliary switch 48 being connected to the rear narrow face wall 47 that is located on the left in the drawing.

The service switching device 40 has a contact point 28 with a moving contact lever 29, to which a transmission element 21 is fitted.

The contact lever 29 interacts with a slide 16, as will be described in more detail further below, with one end 20 of the slide 16 facing the contact lever 29, and touching it.

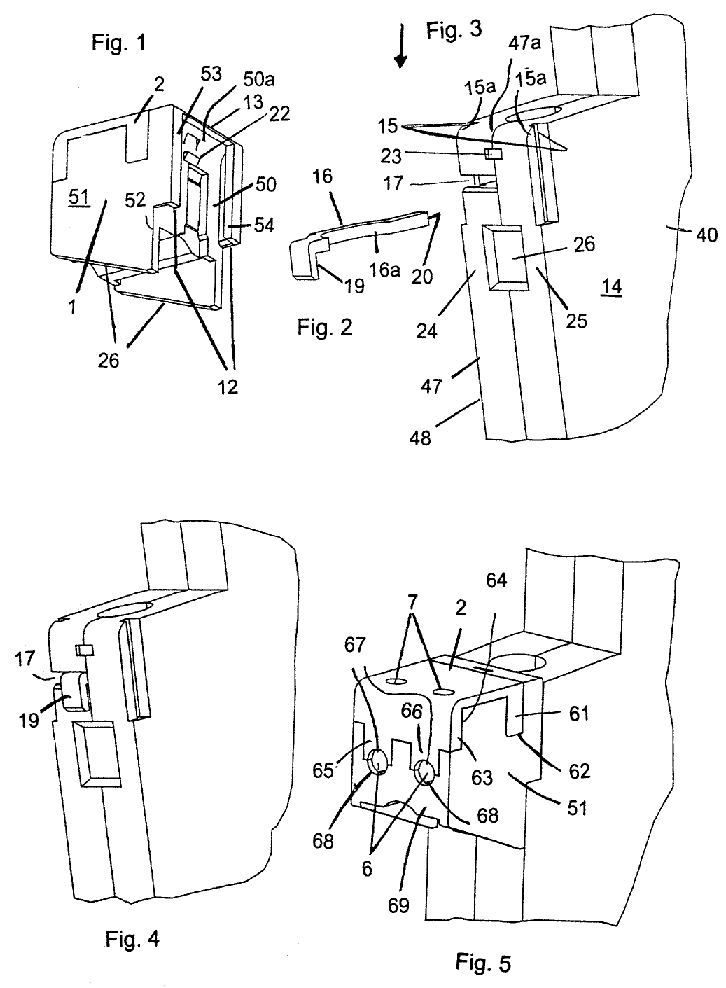

The auxiliary switch 48 has a housing lower part 1 and a housing upper part 2 functioning as a cover (see FIG. 1).

A microswitch 3 and connecting terminals 4, which are connected via lines 5 to the connections of the microswitch 3, are accommodated within the housing lower part 1 (see FIG. 6). One of the connecting terminals 4 is connected to a first connection of the microswitch 3, and the other connecting terminal 4 is connected to the other connection of the microswitch 3.

The connecting terminals 4 have terminal screws 4a which are accessible through two openings 7, see FIGS. 5 and 6, so that the connecting terminals 4 can be operated by a tool. Within the housing lower part 1, there is a sliding piece 9 with a so-called run-on incline 10, which interacts with a plunger 8 of the microswitch 3. A compression spring 11 is located between the microswitch 3 and the sliding element 9, which is L-shaped and of which a first limb 9a has the run-on incline 10 and the other limb 9b, which runs at right angles to the first limb 9a, has a stop for the compression spring 11, this other end makes contact with the microswitch 3. The compression spring 11 is thus seated between the microswitch 3, or one side surface of the microswitch 3, and the limb 9b.

The movement of the moving contact lever 29 is transmitted to the inclined slide or to the element 9 by the slide or plunger 16. The slide 16 is L-shaped, as shown in FIG. 2, with an elongated limb 16a and a web 19. The web 19 rests on the other limb 9b of the sliding piece 9.

FIG. 3 shows a perspective view of the service switching device 40, showing the rear narrow face wall 47 there. As can be seen, the service switching device 40 has a housing with two shell halves 24 and 25. The one shell half 24, which is shown at the rear in the drawing in FIG. 3, has a slot 17 on the rear narrow face wall 47, through which slot 17 the longer arm 16a of the slide 16 can be passed. FIG. 4 illustrates the mounted state.

FIG. 1 will now be used for reference.

The housing part 1 has a back rear wall 50, which is matched to the rear narrow face wall 47 and, in the mounted state, also rests against the narrow face wall 47. L-shaped wall sections 12, which project in the direction of the narrow face wall 47 and whose free limb ends 53 and 54 point towards one another, are located on side walls 51, which run parallel to the broad faces 14 of the service switching device 40, and on the corners which are adjacent to the rear wall 50, that is to say the corners between the side walls 51 and the rear wall 50. Those ends of the wall sections 53 and 54 that are located opposite the mounting plane of the switching device 40 are connected by a transverse wall 13.

U-shaped channels 15 are located on the broad faces or surfaces 14 of the service switching device 40 and run parallel to the narrow face wall 47, from which channels 15 limbs 15a, which are adjacent to the narrow face wall 47, are offset inwards with respect to the broad faces 14, so that the free ends of the limbs 15a are closer to one another than the two broad face surfaces 14.

There is a latching tap 22 adjacent to the rear wall 50, and the latching tap 22 interacts with a recess 23 on the service switching device 40, as a latching mechanism.

For mounting, the slide 16 is pushed through the slot 17 into the interior of the switching device 40, and the auxiliary switching housing lower part 1 and the upper part 2 are then mounted on the circuit breaker 40, in which the limbs 53 and 54 (which point towards one another) are inserted into the grooves 15, with the insertion direction running from above at right angles to the front surface and parallel to the rear side surface. The rear wall 50 has a hollow rounded region 50a, which corresponds to a rounded region 47a and, together with the transverse wall 13, limits the insertion of the auxiliary switch 48.

The side walls 51 of the auxiliary switch 48 have walls which run parallel to them, downwards, that is to say projecting in the mounting direction, which walls are located on both sides of an opening 26 through which a connecting conductor can be routed in a connecting terminal in the switching device 40.

The service switching device 40 in this case has an accommodation area 60 for a connecting terminal (FIG. 6). A connecting conductor is pushed through between extension pieces and through the opening 26 to the connecting terminal, where it is screwed tight.

As indicated above, the auxiliary switch housing has the housing lower part 1 and the upper part or cover 2, with the cover 2 being U-shaped. A first limb 61, which faces the front narrow face wall of the service switching device and projects at right angles to the mounting plane in the direction of the mounting plane, engages in a recess 62 on the side walls 51 of the housing lower part 1 (FIG. 5). Another limb 63 projects into an undercut 64 on the housing lower part 1. Two lugs 65 and 66, which project at right angles to the mounting plane, are also integrally formed there, and their end edges have semicircular cutouts 67 which, together with correspondingly matched cutouts 68 on the housing lower part 1 and on a front wall 69, which is located on the opposite side to the rear wall 50 and runs parallel to the rear wall 50, form a through-opening 6 for connection of the signal lines for the auxiliary switch.

We claim:

1. A service switching device of a cap type, comprising:
a housing having a mounting plane, a rear narrow face wall, and broad faces adjacent said rear narrow face wall, said broad faces having openings formed therein selected from the group consisting of grooves and slots and running parallel to said rear narrow face wall, each of said broad faces having a respective one of said openings; and
an auxiliary switch having a microswitch and fitted on said rear narrow face wall, said auxiliary switch having an auxiliary switch housing with a rear wall and wall sections integrally formed on said rear wall, said walls sections projecting parallel to said broad faces in a direction of said rear narrow face wall, said wall sections having projections matched to said openings, such that said auxiliary switch housing can be mounted on said service switching device by pushing in from a top towards said mounting plane, with said microswitch at right angles to said mounting plane on said rear narrow face wall, and said projections integrally formed on said wall sections sliding in said openings on said broad faces.

2. The service switching device according to claim 1, wherein said wall sections have ends located opposite said mounting plane of said service switching device, and said auxiliary switch housing having a transverse wall connecting said ends of said wall sections.

3. The service switching device according to claim 1, further comprising a latching configuration for holding said auxiliary switch in a mounted state, said latching configuration having a first part integrally formed on said rear wall of said auxiliary switch housing, and a second part formed in said rear narrow face surface.

4. The service switching device according to claim 1, wherein said wall sections are L-shaped and said projections are free limbs pointing towards one another.

5. The service switching device according to claim 4, wherein:
said openings are U-shaped grooves;
said auxiliary switch housing has side walls; and
said housing has limbs disposed between said U-shaped grooves and said rear narrow face wall, and said limbs of said housing are closer to one another than said broad faces, so that said side walls lie flush with said broad faces after mounting of said auxiliary switch.

6. The service switching device according to claim 1,
further comprising a moving contact piece disposed in said housing;
wherein said rear narrow face wall has a slot formed therein;
wherein said microswitch has a plunger;
further comprising an inclined surface disposed in said auxiliary switch;
further comprising a spring disposed next to said microswitch; and
further comprising a slide coupling said microswitch with said moving contact piece, said slide being inserted through said slot in said rear narrow face wall and acts on said inclined surface to operate said plunger of said microswitch against a force of said spring.

7. The service switching device according to claim 6, wherein said slide is L-shaped and has a limb which points towards said mounting plane, outside said rear narrow face wall, in a mounted state.

8. The service switching device according to claim 7, further comprising a sliding piece disposed in said auxiliary switch and said inclined surface is integrally formed on said sliding piece which interacts with said slide.

9. The service switching device according to claim 8, wherein said sliding piece is L-shaped and has a first limb having said inclined surface and a second limb running parallel to said limb of said slide, and said spring being a compression spring is disposed between said microswitch and an inner surface of said second limb of said sliding piece and acting on said slide in a sprung manner in a closing direction of a contact point.
